(19) United States
(12) Patent Application Publication
(10) Pub. No.: US 2006/0256984 A1
(43) Pub. Date: Nov. 16, 2006

(54) Dual base of an electret condenser microphone and electret condenser microphone using the same

(76) Inventors: Chungdam Song, Seoul (KR); Kyunghwan Kang, Siheung-si (KR); Kyoungku Han, Gwangmyeong-si (KR)

Correspondence Address: CANTOR COLBURN, LLP, 55 GRIFFIN ROAD SOUTH, BLOOMFIELD, CT, 06002, US

(21) Appl. No.: 11/404,311

(22) Filed: Apr. 14, 2006

(30) Foreign Application Priority Data
Apr. 25, 2005 (KR) 10-2005-33966

(51) Int. Cl. H04R 25/00

(52) U.S. Cl. 381/174

(57) ABSTRACT

The present invention describes an electret condenser microphone having a dual base structure wherein a metal ring and an insulation ring are bonded. The electret condenser microphone includes a metal ring having a shape of a spool wherein a center portion is concaved and end portions extrude, an insulation ring surrounding the center portion and extruding with respect to the extruding end portions of the metal ring to form an insulation space between a casing and the metal ring.

### FIELD OF THE INVENTION

The present invention relates to an electret condenser microphone, and in particular, to an electret condenser microphone having a dual base structure wherein a metal ring and an insulation ring are bonded.

### BACKGROUND OF THE INVENTION

FIG. 1 is cross-sectional view schematically illustrating a typical condenser microphone.

Referring to FIG. 1, the typical condenser microphone 10 comprises a metal casing 11 having a cylinder shape and having an acoustic hole 11a disposed on a front plate thereof, a polar ring 12 consisting of a conductive material, a vibrating plate 13, a spacer 14, a ring-shaped first base 15 (alternately referred to as an “insulation base”) consisting of an insulating material, a fixed electrode 16 opposing the vibrating plate 13 and having the spacer 14 therebetween, a second base 17 (alternately referred to as an “conductive base”) consisting of a conductive material, and a PCB 18 having a circuit component and a connection terminal disposed thereon. The condenser microphone 10 is manufactured by sequentially stacking the components and curling (11b) an end of the casing 11. The polar ring 12 and the vibrating plate 13 are bonded together as a single body, and the fixed electrode 16 has a structure wherein a high molecular film is coated on metal plate, namely a back electret plate, to form an electret in case of an electret type microphone.

However, the conventional curling process wherein one end of the casing 11 is curled toward the PCB 18 by applying pressure is problematic in that an acoustic characteristic is degraded due to a distortion of the PCB 18 or a deformation of an internal component when a supporting strength by the base is not sufficient.

### DETAILED DESCRIPTION OF THE INVENTION

It is an object of the present invention to provide a dual base which supports a curling surface of a PCB during an assembly of a microphone.

It is another object of the present invention to provide an electret condenser microphone having the dual base wherein a center portion of a spool-shaped metal ring is surrounded by an extruding insulation ring to support the curling surface by the metal ring to prevent a distortion of the PCB and a deformation of components, thereby improving an acoustic characteristic.

In order to achieve the above object of the invention, there is provided a dual base of a condenser microphone comprising: a metal ring having a shape of a spool wherein a center portion is concaved and end portions extrude; and an insulation ring surrounding the center portion and extruding with respect to the extruding end portions of the metal ring to form an insulation space between a casing and the metal ring.

In order to achieve the above object of the invention, there is provided an electret condenser microphone, the microphone comprising: a casing having a acoustic hole at a bottom surface thereof; a vibrating plate vibrating according to an acoustic pressure being input through the acoustic hole, the vibrating plate beingelectrically connected to the casing; a back electret plate opposing the vibrating plate having a spacer therebetween, the back electret plate including an electret consisting of a metal plate having a high molecule film adhered thereto; a back electret insulation ring for insulation the back electret plate from the casing; a dual base including a metal ring for establishing an electrical connection for the back electret plate and an insulation ring for forming a insulation space between the casing and the metal ring, the metal ring having a shape of a spool wherein a center portion is concaved and end portions extrude, the insulation ring surrounding the center portion and extruding with respect to the end portions of the metal ring; and a PCB having a circuit mounted thereon, the PCB being supported by the metal ring of the dual base to form a back chamber with the back electret plate inside the microphone, wherein the metal ring supports the PCB when an end portion of the casing is curled after the vibrating plate, the back electret plate, the back electret insulation ring, the dual base are stacked in the casing.

As described above, in accordance with the microphone of the present invention, the spool-shaped metal ring at the end portion of the casing supports a curled portion of the PCB during a curling process to prevent the distortion of the PCB and the deformation of the components due to a stress to other components, thereby providing the microphone having an improved acoustic characteristic.

In addition, in accordance with the present invention, the insulation ring is used for only the back electret plate having the electret for the back electret plate to be independent of the dual base so that an area of the back electret plate is increased to increase a strength of the electret while increasing an area of the vibrating plate as well to improve a performance.

While the present invention has been particularly shown and described with reference to the preferred embodiment thereof, it will be understood by those skilled in the art that various changes in form and details may be effected therein without departing from the spirit and scope of the invention as defined by the appended claims.

### BRIEF DESCRIPTION OF THE DRAWINGS

FIG. 1 is cross-sectional view illustrating a conventional electret condenser microphone.

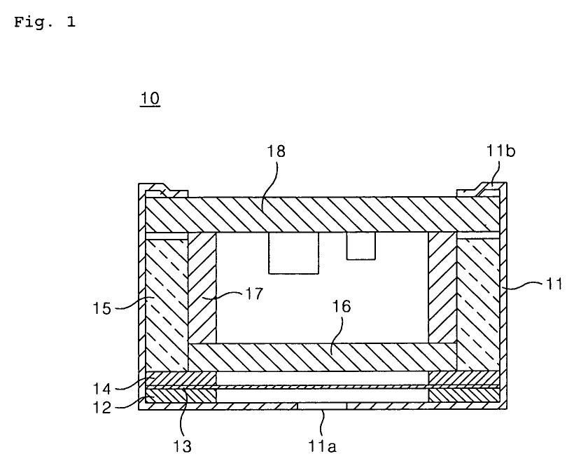

FIG. 2 is a magnified view illustrating a main component of an electret condenser microphone in accordance with the present invention.

FIG. 3 is a perspective view illustrating a disassembled electret condenser microphone in accordance with the present invention.

FIG. 4 is a cross-sectional view illustrating an assembled electret condenser microphone in accordance with the present invention.

### PREFERRED EMBODIMENTS

The above-described objects and other objects and characteristics and advantages of the present invention will now be described in detail with reference to the accompanied drawings.

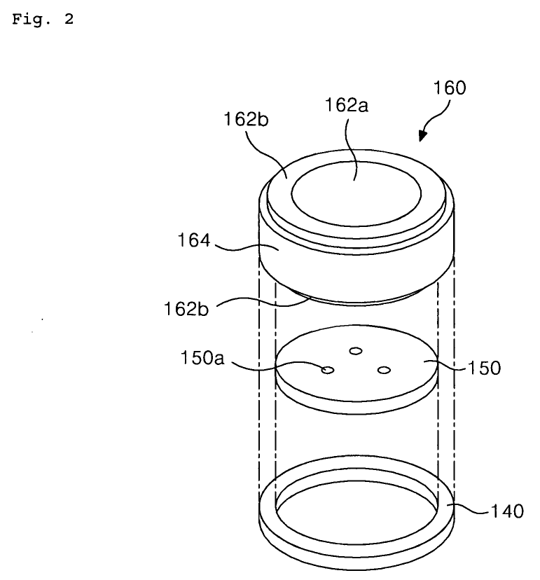

FIG. 2 is a magnified view illustrating a main component of an electret condenser microphone in accordance with the present invention.

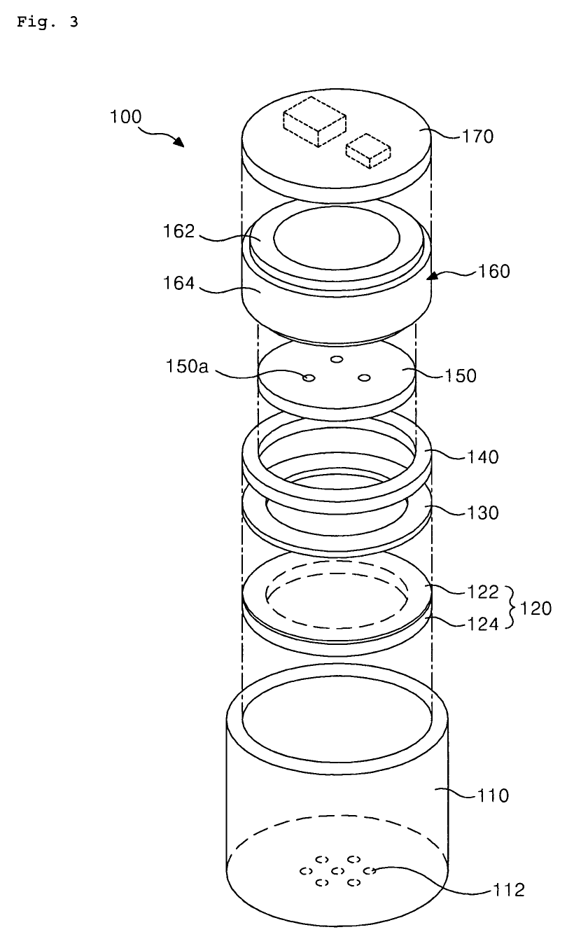

As shown in FIG. 2, the electret condenser microphone in accordance with the present invention comprises a separate back electret plate insulation ring 140 for insulating a back electret plate 150 having a through-hole 150a formed therethrough from a casing (110 of FIG. 3), and a first base for an insulating function and a second base for conducting function constitutes a dual base 160 as a single body.

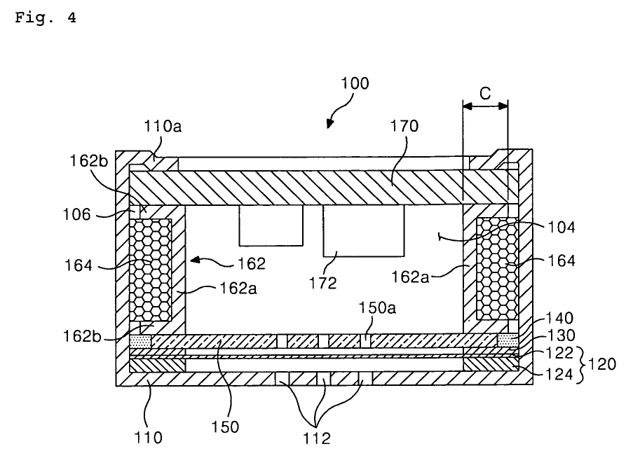

The dual base 160 of the present invention comprises a metal ring 162 an overall shape of which is a spool shape having a concaved center portion wherein both ends of a body 162a having a hollow cylinder shape extrudes outward to form a supporting plate 162b, and an insulation ring 164 which surrounds the concaved center portion of the metal ring 162 and extrudes above the supporting plate 162b at the both ends of the metal ring to form an insulation space between the casing 110 and the metal ring 162 as shown in FIG. 4.

In addition, in accordance with the microphone of the present invention, the insulation ring 140 is used for only the back electret plate 150 having the electret for the back electret plate 150 to be independent of the dual base 160 so that an area of the back electret plate 150 is increased to increase a strength of the electret increasing an area of the vibrating plate 120 as well to improve a performance. That is, while a back electret plate is insulated by inserting a relatively thick first base conventionally, the separate insulation ring 140 insulates the back electret plate 150 as shown in FIG. 2 to increase a size of the back electret plate for increasing the strength of the electret in accordance with the dual base of the present invention.

FIG. 3 is a perspective view illustrating a disassembled electret condenser microphone in accordance with the present invention, and FIG. 4 is a cross-sectional view illustrating an assembled electret condenser microphone in accordance with the present invention.

Referring to FIG. 3, the condenser microphone 100 of the present invention is manufactured by sequentially inserting a vibrating plate 120 including a polar ring 124 and a diaphragm 122, a spacer 130, a back electret plate insulation ring 140, a back electret plate 150, a dual base 160 including a metal ring 162 and a insulation ring 164, and a PCB 170 having a component mounted thereon into a metal casing 110 wherein one end of the casing 110 is open, and then curling the one end of the casing 110 inward to complete an assembly thereof.

As shown in FIG. 4, in accordance with the completely assembled microphone 100, the vibrating plate 120 including the polar ring 124 and the diaphragm 122 is disposed on a bottom surface of the casing 110 wherein a first end of the casing 110 is open and a second end thereof is blocked, and the diaphragm 122 and the back electret plate 150 having the spacer 130 therebetween oppose each other to form an electrode. A plurality of acoustic holes 112 are disposed at the bottom surface of the casing 110, and the diaphragm 122 is electrically connected to the casing 110 through the polar ring 124 which is a conductive supporting member.

The back electret plate 150 comprises a metal plate having an organic film (high molecular film) coated thereon, and an electret is formed on the organic film (high molecular film). The back electret plate 150 is insulated from the casing 110 by the separate back electret plate insulation ring 140. Since an inside diameter of the back electret plate insulation ring 140 is larger than that of the dual base 160, an outside diameter of the back electret plate 150 may be larger than the inside diameter of the dual base 160.

In addition, the metal ring 162 of the dual base 160 supports the back electret plate 150 and connects the back electret plate 150 to the PCB 170 as well. That is, while the first base serving as an insulator performs a supporting function in accordance with the conventional microphone, the pin-cushion shaped metal ring 162 performs the supporting function and the conducting function in accordance with the dual base 160.

A circuit component such as JFET is mounted on a component surface of the PCB 170, and a conductive pattern is formed at a portion where a curling surface 101a of the casing contacts on an opposite surface of the component surface and a connection terminal (not shown) for an external connection is formed. The casing 110 is curled inward by pressing to support the components. As shown in FIG. 4, in accordance with the present invention, the curling is carried out within a supporting range (c) of the metal ring 162 of the dual base to solve many problems occurring due to the curling.

In accordance with the microphone 100, the diaphragm 122 is electrically connected to the PCB 170 through the polar ring 124 and the curling surface of the casing 110, and the back electret plate 150 is electrically connected to the PCB 170 through the metal ring 162 of the dual base 160 to form an electrical circuit.

On the other hand, in accordance with the microphone 100 of the present invention, when an air flows into the microphone through the acoustic holes 112 of the casing 110 by an external acoustic wave, the diaphragm 122 vibrates due to an acoustic pressure while the acoustic pressure also flows into a back chamber 104 formed between the PCB 170 and the back electret plate 150 through a ventilation hole 150a formed on the back electret plate 150. At this instance, when the diaphragm 122 vibrates due to the acoustic pressure flown through the acoustic holes 112, a distance between the diaphragm 122 and the back electret plate 150 varies. When the distance varies, a capacitance formed between the diaphragm 122 and the back electret plate 150 is varied to obtain a variation of an electrical signal (voltage). The signal is transmitted to an IC such as the KFET mounted on the PCB 170 to be amplified and to be transmitted to outside through the connection terminal (not shown).

### INDUSTRIAL APPLICABILITY

A dual base which supports a curling surface of a PCB during an assembly of a microphone is provided. In addition, an electret condenser microphone having the dual base wherein a center portion of a spool-shaped metal ring is surrounded by an extruding insulation ring to support the curling surface by the metal ring to prevent a distortion of the PCB and a deformation of components, thereby improving an acoustic characteristic is provided.

What is claimed is:

1. A dual base of a condenser microphone comprising:
a metal ring having a shape of a spool wherein a center portion is concaved and end portions extrude; and
an insulation ring surrounding the center portion and extruding with respect to the extruding end portions of the metal ring to form an insulation space between a casing and the metal ring.

2. The dual base in accordance with claim 1, wherein the metal ring comprises a cylinder type body having a through-hole therein, and a supporting plate extruding outward at both ends of the body.

3. An electret condenser microphone, the microphone comprising:
a casing having a acoustic hole at a bottom surface thereof;
a vibrating plate vibrating according to an acoustic pressure being input through the acoustic hole, the vibrating plate beingelectrically connected to the casing;
a back electret plate opposing the vibrating plate having a spacer therebetween, the back electret plate including an electret consisting of a metal plate having a high molecule film adhered thereto;
a back electret insulation ring for insulation the back electret plate from the casing;
a dual base including a metal ring for establishing an electrical connection for the back electret plate and an insulation ring for forming a insulation space between the casing and the metal ring, the metal ring having a shape of a spool wherein a center portion is concaved and end portions extrude, the insulation ring surrounding the center portion and extruding with respect to the end portions of the metal ring; and
a PCB having a circuit mounted thereon, the PCB being supported by the metal ring of the dual base to form a back chamber with the back electret plate inside the microphone, wherein the metal ring supports the PCB when an end portion of the casing is curled after the vibrating plate, the back electret plate, the back electret insulation ring, the dual base are stacked in the casing.
